(19) United States
(12) Patent Application Publication
(10) Pub. No.: US 2021/0280336 A1
(43) Pub. Date: Sep. 9, 2021

(54) FLAME RESISTANT MATERIALS FOR ELECTRIC VEHICLE BATTERY APPLICATIONS

(71) Applicant: 3M INNOVATIVE PROPERTIES COMPANY, St Paul, MN (US)

(72) Inventors: Robert H. Turpin, Hill, NH (US); Mitchell T. Huang, Austin, TX (US); Donald A. Gagnon, Franklin, NH (US)

(21) Appl. No.: 17/250,379

(22) PCT Filed: Jul. 22, 2019
(86) PCT No.: PCT/US2019/042776

§ 371 Date: Jan. 13, 2021

Related U.S. Application Data
(60) Provisional application No. 62/703,553, filed on Jul. 26, 2018.
(60) Provisional application No. 62/719,213, filed on Aug. 17, 2018.
(60) Provisional application No. 62/781,724, filed on Dec. 19, 2018.
(60) Provisional application No. 62/848,848, filed on May 16, 2019.

(51) Int. Cl. H01B 3/00; H01B 3/12; H01B 3/08; H01B 3/04; H01M 10/653; H01M 10/0525; H01M 50/24; H01M 10/625; C04B 28/26; C04B 14/42; C04B 14/24; C04B 14/10

(52) U.S. Cl. CPC H01B 3/002; H01B 3/12; H01B 3/084; H01B 3/04; H01M 10/653; H01M 10/0525; C04B 2111/92; H01M 10/625; C04B 28/26; C04B 14/42; C04B 14/24; C04B 14/106; H01M 2220/20; H01M 50/24

(57) ABSTRACT

A flame resistant electrical insulating material comprises glass fibers, a particulate filler mixture, and an inorganic binder, wherein the electrical insulating material has a UL-94 flammability rating of V-0, 5VA and a thermal conductivity of less than 0.15 W/m-K. The particulate filler mixture comprises at least two particulate filler materials selected from the list of glass bubbles, kaolin clay, talc, mica, calcium carbonate, and alumina trihydrate. In an exemplary aspect, the insulating material is not punctured after direct exposure to 2054° C. (3730° F.) flame for at least 10 minutes.

### BACKGROUND OF THE INVENTION

### Field of the Invention

The present invention is directed to a flame resistant electrical insulating material for use in electric vehicles. In particular, the exemplary electrical insulating material can be formed as flame resistant inorganic paper(s) or board(s) capable of passing UL 94-V0, 5VA flame resistance tests. In addition, some exemplary flame resistant inorganic paper or board materials can withstand direct exposure to a 2054° C. (3730° F.) flame for at least 10 minutes without puncturing. Such inorganic paper or boards are thus useful as a protective device, such as a thermal or flame barrier for electric vehicle battery applications.

### BACKGROUND

Growth of battery electric vehicles powered by lithium ion battery packs has created a need for containing the potential dangers associated with thermal runaway reactions in the lithium ion batteries. Currently, electric vehicles manufacturers have diverse requirements and approaches for the use of battery insulation materials. One conventional approach employs mica board as a flame resistant barrier in some electric vehicle battery applications where the requirement is to withstand a high temperature torch for up to ten minutes without puncturing or breaking.

While mica boards (e.g., boards including at least 80% mica) are excellent flame barrier material, they are not ideal for some electric vehicle applications. The high density of mica boards can make mica boards a less attractive solution for electric vehicle battery applications desiring lighter weight materials. Additionally, the ability to adhere mica boards to a substrate or other product parts may limit their use in certain applications.

Inorganic ceramic papers are made from refractory ceramic fibers and can provide excellent high temperature (>1000C) thermal insulation and flame resistance properties. However, refractory ceramic fibers are classified as being possibly carcinogenic to humans (Group 2B) by the International Agency for Research on Cancer (IARC). While low biopersistent refractory ceramic fibers have been developed to address the health concerns, they are more expensive.

The space allowed for flame barrier materials in many electric vehicles can be quite limited (e.g., less than 3 mm) which restricts the use of many thicker flame barrier and thermally insulating materials. Additionally, due to the wide range of battery modules and pack designs, as well as, the different battery cell types with varying levels of energy density, flame resistant materials are needed at varying levels of performance. The trend in the electric vehicle industry is towards the use of higher energy density battery cells as a means to increased driving range. Thus, there is a need for higher performing flame resistant materials that are thin, cost effective, lightweight materials that are capable of withstanding rigorous flammability tests, especially having resistance to high temperature torch flame conditions.

### SUMMARY

Exemplary electrical insulating materials in the form of flame resistant, inorganic paper(s) or board(s) of the present invention are able to withstand harsh, high temperature flammability tests while also providing low thermal conductivity for thermal insulation and low density for reduced weight. Formulations can be tailored to meet differing customer requirements or enhance functionality.

In a first embodiment, a flame resistant electrical insulating material comprises glass fibers, a particulate filler mixture, and an inorganic binder, wherein the electrical insulating material has a UL-94 flammability rating of V-0, 5VA and a thermal conductivity of less than 0.15 W/m-K. The particulate filler mixture comprises at least two particulate filler materials selected from the list of glass bubbles, kaolin clay, talc, mica, calcium carbonate, and alumina trihydrate.

In a second embodiment, a flexible flame resistant electrical insulating material comprises glass fibers, a particulate filler mixture, and an inorganic binder, wherein the electrical insulating material has a UL-94 flammability rating of V-0, 5VA, and wherein the flexible material is capable of wrapping around a mandrel without cracking or damaging the material. The particulate filler mixture comprises at least two particulate filler materials selected from the list of glass bubbles, kaolin clay, talc, mica, calcium carbonate, and alumina trihydrate.

In a third embodiment, a flame resistant electrical insulating material comprises glass fibers, a particulate filler mixture, and an inorganic binder, wherein the electrical insulating material has a UL-94 flammability rating of V-0, 5VA. The particulate filler mixture comprises at least two particulate filler materials selected from the list of glass bubbles, kaolin clay, talc, mica, calcium carbonate, and alumina trihydrate.

In a fourth embodiment, a flame resistant electrical insulating material comprises 3 wt. % to 25 wt. % glass fibers; 20 wt. % to 80 wt. % of kaolin clay; 5 wt. % to 15 wt. % glass bubbles; and 5 wt. % to 20 wt. % inorganic binder, based on the composition of the insulating material and wherein the insulating material has a UL-94 flammability rating of V-0, 5VA.

In some instances of the first thru forth embodiments cited above, the exemplary flame resistant inorganic paper or board materials can withstand direct exposure to a 2054° C. (3730° F.) flame for at least 10 minutes without puncturing.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

FIG. 1 shows an exemplary battery module that includes a thermal barrier formed from an insulation material according to an aspect of the invention.

FIG. 2 shows an exemplary battery pack that includes a thermal barrier formed from an insulation material according to an aspect of the invention.

### DETAILED DESCRIPTION OF THE EMBODIMENTS

In the following Detailed Description, reference is made to the accompanying drawings, which form a part hereof, and in which is shown by way of illustration specific embodiments in which the invention can be practiced. In this regard, directional terminology, such as “top,” “bottom,” “front,” “back,” “forward,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments can be utilized and structural or logical changes can be made without departing from the scope of the present invention. The following detailed description, therefore, is not to be taken in a limiting sense, and the scope of the present invention is defined by the appended claims.

Suitable flame resistant electrical insulating materials include inorganic fibers, such as glass fibers, and are thermally and electrically insulating in the form of an inorganic insulating paper or board. Multiple sheets, i.e., plies or sub-layers of inorganic paper layer may be wet laminated and pressed to yield an inorganic board or a multilayer paper material that is thermally and electrically insulating. The term “paper” refers to a flexible single or multilayer material that has sufficient flexibility to be bent around a 3-in. mandrel. The term “board” refers to a relatively stiff material that can be flexed, but which is not capable to wrap around a mandrel.

Electrical insulating materials of the invention containing one or both of inorganic fibers and inorganic particles may be referred to as inorganic papers or boards depending on thickness and flexibility of the insulating material.

The nonwoven, inorganic papers and boards of the present invention are largely made up of inorganic materials (i.e. inorganic fibers and fillers). In an exemplary embodiment, the exemplary nonwoven, inorganic papers and boards comprise at least 95% inorganic materials. In another embodiment, the exemplary nonwoven, inorganic papers and boards comprise at least 98% inorganic materials. The highly inorganic nature of the exemplary nonwoven, inorganic papers and boards enhances the flame resistance of these materials over most conventional insulating papers.

Exemplary flame-resistant nonwoven, inorganic papers or boards are able to pass UL 94-V0, 5VA flame resistance tests and withstand direct exposure to a 2054° C. (3730° F.) flame for at least 10 minutes without puncture or breaking. The exemplary flame-resistant materials, described herein, are also lower density than mica boards, leading to a lower weight insulation solution which is important to electric vehicle manufacturers. The exemplary flame-resistant materials also have a lower thermal conductivity than mica boards which reduces the rate of heat transfer to minimize or reduce the propagation of a thermal runaway event to neighboring flammable components, which can reduce the overall severity of the event.

The exemplary inorganic paper comprises a combination of glass fibers and microglass fibers. These fibers interlock together to form the structural support of the inorganic fillers.

The glass fiber content of the paper will be from about 3 wt. % to 25 wt. %, with the ratio of glass staple fibers to micro glass fibers being 5:1 to 1:3.

The diameter of the glass fibers can affect the processing of the paper, as well as the final performance of the resulting inorganic papers or boards. Exemplary glass staple fibers diameters are 12 microns or less, although small amounts of larger diameter fibers may be incorporated.

Smaller diameter glass fibers have a greater surface area than an equivalent amount of larger diameter fibers enabling entrapment of an increase amount of particulate filler materials. The microglass fibers used in the present invention typically have a diameter of less than 5 microns. The working diameter range for the glass fibers and glass microfibers is from about 0.1 micron to about 12 microns.

The length of the glass fibers is selected to obtain a uniform dispersion of the glass fibers in the slurry used to make the exemplary papers. It is noted that if the glass fibers are too short there may not be sufficient interlocking between the fibers, and the strength of the resulting paper and boards may be diminished. If the glass fibers are too long, it can be difficult to obtain the uniform dispersion needed. Thus, the glass fibers should have an average length less than 0.5 inch (12,700 microns) and more preferably about 0.25 inch (6350 microns) and greater than 0.125 inch (3175 microns).

The glass fibers may also be further identified by a length-to-diameter (L/D) ratio. The exemplary L/D ratio for the glass staple fibers used in the exemplary papers and boards are between 3000:1 and 200:1, preferably about 1000:1.

In at least one embodiment of the present invention, the nonwoven paper also comprises one or more inorganic particulate fillers. Exemplary inorganic particulate fillers are generally non-endothermic. Suitable inorganic particulate fillers include, but are not limited to, glass bubbles, kaolin clay, talc, mica, calcium carbonate, wollastonite, montmorillonite, smectite, bentonite, illite, chlorite, sepiolite, attapulgite, halloysite, vermiculite, laponite, rectorite, perlite, and combinations thereof, preferably a particulate filler mixture comprises at least two of glass bubbles, kaolin clay, talc, mica, calcium carbonate, and alumina trihydrate. Suitable types of kaolin clay include, but are not limited to, water-washed kaolin clay; delaminated kaolin clay; calcined kaolin clay; and surface-treated kaolin clay. In a preferred embodiment, inorganic particulate filler comprises glass bubbles, kaolin clay, mica and mixtures thereof. Optionally, an endothermic filler, such as alumina trihydrate, can be added.

The particulate inorganic filler content of the paper will be from about 65 wt. % to 87 wt. %. In the exemplary papers of the present invention comprise a mixture of particulate inorganic fillers. For example, the exemplary papers and boards comprise between about 20 wt. % to 45 wt. % of kaolin clay, from about 25 wt. % to 45 wt. % mica, and from about 5 wt. % to 15 wt. % glass bubbles based on the total weight of the exemplary paper. In an alternative embodiment, the exemplary papers and boards comprise between about 55 wt. % to 80 wt. % of kaolin clay and from about 5 wt. % to 15 wt. % glass bubbles based on the total weight of the exemplary paper.

The exemplary inorganic paper further comprises 5 wt. %-20 wt. %, preferably 5 wt. %-15 wt. % inorganic binder. The inorganic binder can be selected from sodium silicate, lithium silicate, potassium silicate or a combination thereof.

Additional processing aids such as defoamers, surfactants, forming aids, pH-adjusting materials, paper strengthening agents, and etc. known to those skilled in the art can also be incorporated.

The above electrical insulating materials can be used in a protective device or system, such as a thermal/flame barrier. For example, one or more sheets of an exemplary electrical insulating material can be incorporated into or wrapped around a flammable energy storage device, such as lithium ion battery cells, modules, or packs, such as may be found in hybrid or electric vehicles or other electric transportation applications or locations.

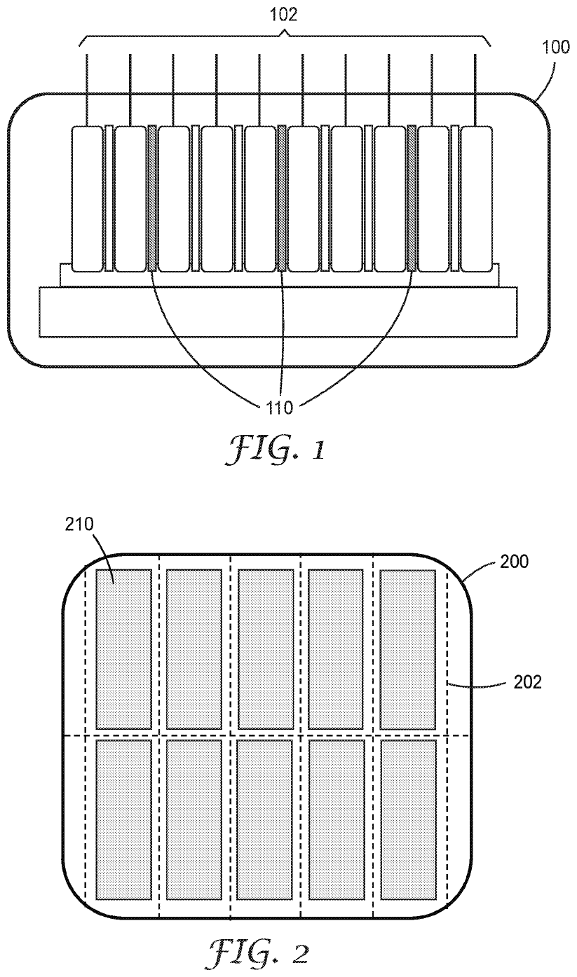

For example, FIG. 1 shows an implementation of the exemplary insulation materials described herein. In FIG. 1, a battery module 100 includes an assembly of battery cells 102. One or more thermal barrier/flame resistant sheets or boards 110, formed from the exemplary materials described herein, can be disposed between individual battery cells or groups of cells at one or more locations throughout the battery module.

In another example implementation, FIG. 2 shows a lithium ion battery pack 200 that includes a plurality of lithium ion battery modules 202. A series of thermal barrier/flame resistant encasement liners 210, formed from the exemplary materials described herein, are provided to encase one or more of the lithium ion battery modules 202. In this example, each of the lithium ion battery modules are encased by a thermal barrier/flame resistant encasement liner 210. Alternatively, one or more sides of the lithium ion battery pack 200 itself can be wrapped or lined with a thermal barrier/flame resistant encasement liner.

In some exemplary aspects, the exemplary insulation materials described herein can be combined with other functional layers. For example, the exemplary insulation materials can be laminated to an inorganic fabric capable of withstanding not only high temperatures, but high pressures as well, to withstand gas venting and particle blow with minimal damage. The multilayer material according to the invention may comprise an inorganic fabric which comprises E-glass fibers, R-glass fibers, ECR-glass fibers, basalt fibers, ceramic fibers, silicate fibers, steel filaments or a combination thereof. The fibers may be chemically treated. The inorganic fabric can be a woven fabric, a knitted fabric, a stitch bonded fabric, a crocheted fabric, an interlaced fabric or a combination thereof. In some embodiments, the inorganic fabric is a woven basalt fabric.

The exemplary electrical insulating materials described herein utilize can utilize relatively low temperature glass fibers that are typically used at temperatures below 600° C. in combination with filler particles and inorganic binder to achieve high temperature (2000° C.) torch flame resistance.

Of course, these examples are just a few of many types of implementations for the materials described herein, as would be apparent to one of ordinary skill in the art given the present description.

### EXAMPLES

These examples are for illustrative purposes only and are not meant to be limiting on the scope of the appended claims. All parts, percentages, ratios, etc. in the examples and the rest of the specification are by weight, unless otherwise noted.

### Test Methods

| | Test Method |
|---|---|
| Thickness | ASTM D645 - Standard Test Method for |
| | Thickness of Paper and Paperboard |
| Basis | ASTM D202 - Standard Test Method for |
| Weight | Sampling and Testing Untreated Paper |
| | Used for Electrical Insulation |
| Dielectric | ASTM D-149 - Standard Test Method for |
| Breakdown | Dielectric Breakdown Voltage and |
| Voltage | Dielectric Strength of Solid Electrical |
| | Insulating Materials at Commercial Power |
| | Frequencies. |
| Thermal | ASTM D-5470 - Standard Test Method for |
| Conductivity | Thermal Transmission Properties of |
| | Thermally Conductive Electrical |
| | Insulation Materials |
| Gurley | ASTM D-6125 - Standard Test Method for |
| Stiffness | Bending Resistance of Paper and Paperboard |
| | (Gurley Type Tester) |
| Tensile Strength | ASTM D828 |
| Elongation to Break | ASTM D828 |
| Flammability | UL-94 - Standard for Tests for Flammability |
| | of Plastic Materials for Parts in Devices |
| | and Appliances |

### Density

The density of the exemplary paper or board materials is calculated by dividing the basis weight by the thickness.

### Flexibility

The flexibility of the exemplary paper or board materials was determined by bending the materials around a 3-inch mandrel of known diameter without cracking or damaging the material.

### Torch Flame Test

The torch flame test was conducted using a Bernzomatic torch TS-4000 trigger equipped with a MAP Pro fuel cylinder that provides a flame temperature in air of 2054° C./3730° F. Test samples were mounted at a fixed distance of 1″ (2.54 cm) from the flame with a metal clip attached at the bottom of the sample to help stabilize the sample against the pressure of the flame and exposed to the flame for a continuous time period of 10 minutes or until the sample was punctured from the flame.

### Sandblast Test

A sandblast cabinet (Empire Abrasive Equipment Company, Langhorne, Pa.) was used to provide an assessment of resistance to a blast of particles. The sample test material was mounted on top of a 3″ (76 mm)×6″ (152 mm) metal plate. This sample assembly was then mounted into a fixture within the cabinet and held in place with clamps. The sandblast nozzle was fixed at a distance approximately 6″ (152 mm) from the sample and tests were conducted at room temperature. Steel grit GH40 was used as the blast media and actual compressed air pressure was about 30 psi. A time exposure of 15 seconds was used.

### Materials

EC6-6 E-glass chopped strand fibers (6 mm length, 6 μm diameter), available from Lauscha Fiber International Corporation (Charlotte, N.C.).

B-06-F microglass fibers (0.65 μm diameter, 2.47 m²/g surface area), available from Lauscha Fiber International Corporation (Charlotte, N.C.).

B-26-R microglass fibers (2.44 μm diameter, 0.66 m²/g surface area), available from Lauscha Fiber International Corporation (Charlotte, N.C.).

S15 glass bubbles, available from3M Company (St. Paul, Minn.).

Suzorite 200-HK phlogopite mica, available from Imerys (Boucherville, Quebec).

Suzorite 20S mica available from Imerys (Roswell, Ga.).

Delaminated kaolin clay Hydraprint, available from Kamin LLC (Macon, Ga.).

Calcined kaolin clay Kamin 70C, available from Kamin LLC (Macon, Ga.).

N-sodium silicate, available from PQ Corporation (Valley Forge, Pa.).

K® sodium silicate (SiO2/Na2O weight ratio=2.88, viscosity at 20° C.=9.6 poise) available from PQ Corporation (Valley Forge, Pa)

TW-600-13-100 basalt twill weave fabric (600 gsm basis weight) available from Sudaglass Fiber Technology, Inc (Houston, Tex., USA).

### Example 1-P

### Paper

A mixture of 4.1 wt. % EC6-6 E-glass fibers (6 mm length, 6 μm diameter), 3.1 wt. % B-06-F microglass fibers (0.65 p.m diameter, 2.47 m²/g), 28.6 wt. % 200-HK phlogopite mica, 24.5 wt. % calcined kaolin clay Kamin 70C, 9.2 wt. % S15 glass bubbles, 5.1 wt. % phlogopite 20S mica, were pre-dispersed in water to form an aqueous slurry with a solids content of about 0.05-1% by weight in a Waring blender and then mixed into a larger container with 15.2 wt. % delaminated kaolin clay Hydraprint and 10.2 wt. % N-sodium silicate. Additional materials such as defoamers, surfactants, forming aids, pH-adjusting materials, known to those skilled in the art can also be incorporated. Dewatering was done through a papermaking screen and press (Williams Standard Pulp Testing Apparatus) to form a flame resistant paper material.

### Example 1-L

### Laminate

Eight layers of flame resistant paper material of Example 1-P were stacked together prior to pressing and drying to obtain a higher thickness flame resistant board material. Test results are shown in Table 1.

### Example 2-P

### Paper

A mixture of 5.2 wt. % EC6-6 E-glass fibers (6 mm length, 6μm diameter), 2.1 wt. % B-06-F microglass fibers (0.65 μm diameter, 2.47 m²/g), 27.8 wt. % 200-HK phlogopite mica, 24.7 wt. % calcined kaolin clay Kamin 70C, 7.2 wt. % S15 glass bubbles, 9.3 wt. % phlogopite 20S mica, were pre-dispersed with water to form an aqueous slurry with a solids content of about 0.05-1% by weight in a Waring blender and then mixed into a larger container with 13.4 wt. % delaminated kaolin clay Hydraprint and 10.3 wt. % N-sodium silicate. Additional materials such as defoamers, surfactants, forming aids, pH-adjusting materials, known to those skilled in the art can also be incorporated. Dewatering was done through a papermaking screen and press (Williams Standard Pulp Testing Apparatus).

### Example 2-L

### Laminate

Four layers of flame resistant paper material of Example 2-P were stacked together prior to pressing and drying to obtain a higher thickness flame resistant paper material. Test results are shown in Table 1.

### Example 3-P

### Paper

A mixture of 6 wt. % EC6-6 E-glass fibers (6 mm length, 6 μm diameter), 14 wt. % B-26-R microglass fibers (2.44 μm diameter, 0.66 m²/g), 2 wt. % B-06-F microglass fibers (0.65 μm diameter, 2.47 m²/g), 45 wt. % calcined kaolin clay Kamin 70C, 9 wt. % S15 glass bubbles, were dispersed with water to form an aqueous slurry with a solids content of about 0.05-1% by weight and then mixed into a larger container with 13 wt. % delaminated kaolin clay Hydraprint and 11 wt. % N-sodium silicate. Additional materials such as defoamers, surfactants, forming aids, pH-adjusting materials, known to those skilled in the art can also be incorporated. Dewatering was done through a papermaking screen and press (Williams Standard Pulp Testing Apparatus).

### Example 3-L

### Laminate

Two layers of flame resistant paper material of Example 3-P were stacked together prior to pressing and drying to obtain a higher thickness flame resistant paper material. Test results are shown in Table 1.

### Example 4-P

### Paper

A mixture of 7.2 wt. % EC6-6 E-glass fibers (6 mm length, 6 μm diameter), 4.6 wt. % B-26-R microglass fibers (2.44 μm diameter, 0.66 m²/g), 3.2 wt. % B-06-F microglass fibers (0.65 μm diameter, 2.47 m²/g), 44 wt. % calcined kaolin clay Kamin 70C, 9 wt. % S15 glass bubbles, were dispersed with water to form an aqueous slurry with a solids content of about 0.05-1% by weight and then mixed into a larger container with 22 wt. % delaminated kaolin clay Hydraprint and 10 wt. % N-sodium silicate. Dewatering was done through a papermaking screen and press (Williams Standard Pulp Testing Apparatus).

### Example 4-L

### Laminate

Two layers of flame resistant paper material of Example 4-P were stacked together prior to pressing and drying to obtain a higher thickness flame resistant paper material. Test results are shown in Table 2.

### Example 5-P

### Paper

A mixture of 7 wt. % EC6-6 E-glass fibers (6 mm length, 6μm diameter), 4.9 wt. % B-26-R microglass fibers (2.44 μm diameter, 0.66 m²/g surface area), 2.1% B-06-F microglass fibers (0.65 μm diameter, 2.47 m²/g), 35 wt. % 200-HK phlogopite mica, 7 wt. % calcined kaolin clay Kamin 70C, 9 wt. % S15 glass bubbles, 7 wt. % phlogopite 20S mica, were pre-dispersed with water to form an aqueous slurry with a solids content of about 0.05-1% by weight in a Waring blender and then mixed into a larger container with 18 wt. % delaminated kaolin clay Hydraprint and 10 wt. % N-sodium silicate. Dewatering was done through a papermaking screen and press (Williams Standard Pulp Testing Apparatus).

### Example 5-L

### Laminate

Four layers of flame resistant paper material of Example 5-P were stacked together prior to pressing and drying to obtain a higher thickness flame resistant paper material. Test results are shown in Table 2.

### Example 6-B

### Board

A mixture of 6.9 wt. % EC6-6 E-glass fibers (6 mm length, 6 μm diameter), 2.5 wt. % B-26-R microglass fibers (2.44 μm diameter, 0.66 m²/g surface area), 2.6% B-06-F microglass fibers (0.65 μm diameter, 2.47 m²/g), 35 wt. % 200-HK phlogopite mica, 7 wt. % calcined kaolin clay Kamin 70C, 9 wt. %S15 glass bubbles, 7 wt. % phlogopite 20S mica, and 20 wt. % Hydraprint clay were pre-dispersed in water at about a 10 wt. % solids content in a Hydrabeater and then transferred to a beater chest that contained a dispersion of 6.9 wt. % EC6-6 E-glass fibers (6 mm length, 6 μm diameter) and 10 wt. % sodium silicate at about a 0.5 wt. % solids. Additional water was added during the final mixing so that the final aqueous slurry solids content was about 1.4 wt. %. The aqueous slurry was then transferred to a millboard machine to make boards in a continuous batch process. After board materials were made, they were dried in an oven for about 8 hours at 300° F. Test results are shown in Table 2.

### Example 7-P

### Paper

A mixture of 6.9 wt. % EC6-6 E-glass fibers (6 mm length, 6 μm diameter), 3.1 wt. % B-26-R microglass fibers (2.44 μm diameter, 0.66 m²/g surface area), 2 wt. % B 06 F microglass fibers (0.65 μm diameter, 2.47 m²/g), 28 wt. % 200-HK phlogopite mica, 7 wt. % calcined kaolin clay Kamin 70C, 9 wt. % S15 glass bubbles, 14 wt. % phlogopite 20S mica, were pre-dispersed with water to form an aqueous slurry with a solids content of about 0.05-1% by weight in a Waring blender and then mixed into a larger container with 18 wt. % delaminated kaolin clay Hydraprint and 12 wt. % N-sodium silicate. Dewatering was done through a papermaking screen and press (Williams Standard Pulp Testing Apparatus).

### Example 7-L

### Laminate

Eight layers of flame resistant paper material of Example 7-P were stacked together prior to pressing and drying to obtain a higher thickness flame resistant paper material. Test results are shown in Table 2.

### Example 8-B

### Board

A mixture of 3.2 wt. % B-26-R microglass fibers (2.44 μm diameter, 0.66 m²/g surface area), 1.9% B 06 F microglass fibers (0.65 μm diameter, 2.47 m²/g), 35 wt. % 200-HK phlogopite mica, 4.3 wt. % calcined kaolin clay Kamin 70C, 4.7 wt. % S15 glass bubbles, 14 wt. % phlogopite 20S mica, and 21 wt. % Hydraprint clay were pre-dispersed in water at about a 10 wt. % solids content in a Hydrabeater and then transferred to a beater chest that contained a dispersion of 6.9 wt. % EC6-6 E-glass fibers (6 mm length, 6 μm diameter) and 9 wt. % sodium silicate at about a 0.5 wt. % solids. Additional water was added during the final mixing so that the final aqueous slurry solids content was about 1.4 wt. %. The aqueous slurry was then transferred to a millboard machine to make boards in a continuous batch process. After board materials were made, they were dried in an oven for about 8 hours at 300° F. Test results are shown in Table 3.

### Example 9-P

### Paper

A mixture of 6.9 wt. % EC6-6 E-glass fibers (6 mm length, 6 μm diameter), 4.9 wt. % B-26-R microglass fibers (2.44 μm diameter, 0.66 m²/g surface area), 1.2 wt. % B 06 F microglass fibers (0.65 μm diameter, 2.47 m²/g), 28 wt. % 200-HK phlogopite mica, 3.5 wt. % calcined kaolin clay Kamin 70C, 3.1 wt. % S15 glass bubbles, 7 wt. % phlogopite 20S mica, were pre-dispersed with water to form an aqueous slurry with a solids content of about 0.05%-1% by weight in a Waring blender and then mixed into a larger container with 36.4 wt. % delaminated kaolin clay Hydraprint and 9 wt. % N-sodium silicate. Dewatering was done through a papermaking screen and press (Williams Standard Pulp Testing Apparatus).

### Example 9-L

### Laminate

Four layers of flame resistant paper material of Example 9-P were stacked together prior to pressing and drying to obtain a higher thickness flame resistant paper material. Test results are shown in Table 3.

### Example 10-L

### Laminate

Example 8-B was coated with a bead of K® sodium silicate using a syringe. A #30 Mayer rod was then used to draw down and coat the entire sample area. The TW-600-13-100 fabric was placed over the Example 8-B sample and rolled with a 10 lb roller to laminate the fabric layer to the surface of the Example 8-B board. This laminate was then dried at 180° F. (82° C.) for 5 minutes. Test results are shown in Table 3.

### Example 11-L

### Laminate

Example 9-L was coated with a bead of K® sodium silicate using a syringe. A #30 Mayer rod was then used to draw down and coat the entire sample area. The TW-600-13-100 fabric was placed over the Example 9-L sample and rolled with a 10 lb roller to laminate the fabric layer to the surface of the Example 9-L laminate. This laminate was then dried at 180° F. (82° C.) for 5 minutes. Test results are shown in Table 3.

### Comparative Example 1

A 0.046″ thick COGEMICANITE 132-1P PHLOGOPITE FLEXIBLE MICA SHEET, available from COGEBI (Netherlands). Test results are shown in Table 1.

### Comparative Example 2

A 1.16 mm Ax-therm rigid mica sheet, available from Axim Mica (Robbinsville Township, N.J.). Test results are shown in Table 1.

### Comparative Example 3

A 0.046″ thick COGEMICANITE 132-1M MUSCOVITE FLEXIBLE MICA SHEET, available from COGEBI (Netherlands). Test results are shown in Table 2.

### Comparative Example 4

A mixture of 6.9 wt. % EC6-6 E-glass fibers (6 mm length, 6 μm diameter), 4.9 wt. % B-26-R microglass fibers (2.44 μm diameter, 0.66 m²/g surface area), 1.2 wt. % B 06 F microglass fibers (0.65 μm diameter, 2.47 m²/g), 28 wt. % 200-HK phlogopite mica, 7 wt. % calcined kaolin clay Kamin 70C, 7 wt. % phlogopite 20S mica, were pre-dispersed with water to form an aqueous slurry with a solids content of about 0.05 1% by weight in a Waring blender and then mixed into a larger container with 36 wt. % delaminated kaolin clay Hydraprint and 9 wt. % N-sodium silicate. Dewatering was done through a papermaking screen and press (Williams Standard Pulp Testing Apparatus).

Four layers of flame resistant paper material were stacked together prior to pressing and drying to obtain a higher thickness flame resistant paper material. Test results are shown in Table 3.

### Comparative Example 5

A mixture of 6.9 wt. % EC6-6 E-glass fibers (6 mm length, 6 μm diameter), 7.9 wt. % B-26-R microglass fibers (2.44 μm diameter, 0.66 m²/g surface area), 1.2 wt. % B 06 F microglass fibers (0.65 μm diameter, 2.47 m²/g), 28 wt. % 200-HK phlogopite mica, 3.5 wt. % calcined kaolin clay Kamin 70C, 7 wt. % phlogopite 20S mica, were pre-dispersed with water to form an aqueous slurry with a solids content of about 0.05 1% by weight in a Waring blender and then mixed into a larger container with 36.5 wt. % delaminated kaolin clay Hydraprint and 9 wt. % N-sodium silicate. Dewatering was done as previously described. Four layers of flame resistant paper material were stacked together prior to pressing and drying to obtain a higher thickness flame resistant paper material. Test results are shown in Table 3.

Comparative examples 4 and 5 contain no glass bubbles and failed the torch test with burn thru holes after 5 and 2 minutes, respectively. While glass bubbles are typically used for density reduction and thermal insulation purposes, the contribution to preventing a burn thru hole from a high temperature torch for these inventive materials is unexpected.

Flame testing was conducted on four conventional electrical insulating materials (Comparative Samples 6-9) that are used in applications requiring a measure of flame retardancy. Results of flame testing are presented in Table 4. The results also demonstrate that the torch flame test exposes the sample to much more intense heat and flame exposure than standard UL-94V0 and UL-94V0, 5VA test methods.

Comparative Sample 6 is a 125 mil thick piece of Techmat® 4008 High Temperature Glass Fiber Insulation—needled 100% E-glass nonwoven mat available from BGF Industries, Inc (Greensboro, N.C.).

Comparative Sample 7 is a 17 mil thick piece of Formex® GK-17flame retardant polypropylene sheet available from ITW Formex (Carol Stream, Ill.)).

Comparative Sample 8 is a 10 mil thick piece of Nomex®410 m-aramid paper available from DuPont (Wilmington, Del.).

Comparative Sample 9 is a 30 mil thick piece of Nomex® 410 m-aramid paper available from DuPont (Wilmington, Del.).

Comparative Sample 10 is a 9 mil thick piece Flame Barrier FRB-NC229 available from 3M Company (St. Paul, Minn.).

TABLE 1
Comparison of Properties for Flame Resistant Materials

| | | | | | | | Comparative | | Comparative | |
|---|---|---|---|---|---|---|---|---|---|---|
| | Example 1-L | | Example 2-L | | Example 3-L | | Sample 1 | | Sample 2 | |
| Thickness | 43 | Mil | 21 | Mil | 15 | Mil | 46.4 | Mil* | 0.1-101.6* | |
| | 1.09 | mm | 0.53 | mm | 0.38 | mm | 1.18 | mm | | |
| Basis | 1.65 | lb/yd² | 0.659 | lb/yd² | 0.432 | lb/yd² | 3.7 | lb/yd² | | |
| Weight | 897 | g/m² | 358 | g/m² | 235 | g/m² | 2009 | g/m² | | |
| Dielectric | 5.0 | kV | 3.4 | kV | 1.9 | kV | >10.2 | kV* | | |
| Breakdown Voltage | | | | | | | | | | |
| Thermal Conductivity | 0.10 | W/m-K | 0.071 | W/m-K | 0.094 | W/m-K | 0.20 | W/m-K* | 0.3 | W/mK* |
| Gurley Stiffness | 37.8 | g | | | | | 0.195 | W/m-K | | |
| Density | 0.81 | g/cm³ | 0.68 | g/cm³ | 0.62 | g/cm³ | 1.7 | g/cm³ | 2.25 | g/cm³* |

| | | | | |
|---|---|---|---|---|
| Tensile | 10 | lb/in | 12.3 | lb/in |
| Strength | 17.5 | N/cm | 21.5 | N/cm |

| | | | | |
|---|---|---|---|---|
| Elongation to Break | | 0.94% | 1.73% | |
| Flexibility | n/a | Pass | Pass | |
| UL-94 Flammability | V-0, 5 VA | V-0, 5 VA | V-0, 5 VA | V-0* |
| Torch | Pass | Pass | Fail - warpage | |
| Flame | | | during test, | |
| Test | | | small holes | |
| | | | formed | |

*values taken from product data sheet

TABLE 2
Comparison of Properties for Flame Resistant Materials

| | | | | | | | | | Comparative | |
|---|---|---|---|---|---|---|---|---|---|---|
| | Example 4-L | | Example 5-L | | Example 6-L | | Example 7-L | | Sample 3 | |
| Thickness | 13 | Mil | 32 | Mil | 41 | Mil | 41 | Mil | 45.8 | Mil |
| | 0.33 | mm | 0.82 | mm | 1.04 | mm | 1.04 | mm | 1.16 | mm |
| Basis | 0.34 | lb/yd² | 1.15 | lb/yd² | 1.45 | lb/yd² | 1.58 | lb/yd² | 3.2 | lb/yd² |
| Weight | 184 | g/m² | 625 | g/m² | 789 | g/m² | 859 | g/m² | 1721 | g/m² |
| Dielectric | 1.8 | kV | 5 | kV | 4.2 | kV | 5.8 | kV | >10.2 | kV* |
| Breakdown Voltage | | | | | | | | | | |
| Thermal | 0.098 | W/m-K | 0.11 | W/m-K | 0.12 | W/m-K | 0.11 | W/m-K | 0.2 | W/m-K* |
| Conductivity | | | | | | | | | | |
| Gurley Stiffness | | | | | 31.9 | g | 50.5 | g | 73 | g |
| Density | 0.55 | g/cm³ | 0.76 | g/cm³ | 0.76 | g/cm³ | 0.83 | g/cm³ | 1.5 | g/cm³* |

| | | | | | | | | |
|---|---|---|---|---|---|---|---|---|
| Tensile | 13 | lb/in | 29 | lb/in | 37 | lb/in | 46 | lb/in |
| Strength | 22.7 | N/cm | 51.2 | N/cm | 65.2 | N/cm | 80 | N/cm |

| | | | | | |
|---|---|---|---|---|---|
| Elongation to Break | 0.75% | 2.6% | 0.55% | 0.37% | |
| Flexibility | Pass | Pass | | | |
| UL-94 Flammability | V-0, 5 VA | V-0, 5 VA | V-0, 5 VA | V-0, 5 VA | V-0* |
| Torch | Fail - warpage | Pass | Pass | Pass | Pass |
| Flame | during test, small | | | | |
| Test | <0.1 inch holes | | | | |
| | after 45 seconds | | | | |
| Sandblast test | | | | Fail, holes | |

*values taken from product data sheet

TABLE 3
Comparison of Properties for Flame Resistant Materials

| | Example | | Example | | Example | | Example | | Comparative | | Comparative | |
|---|---|---|---|---|---|---|---|---|---|---|---|---|
| | 8-B | | 9-L | | 10-L | | 11-L | | Example 4 | | Example 5 | |
| Thickness | 40 | Mil | 20.6 | Mil | 57.3 | mil | 37.6 | Mil | 19.8 | Mil | 21 | Mil |
| | 1.02 | mm | 0.52 | mm | 1.45 | mm | 0.96 | mm | 0.5 | mm | 0.53 | mm |
| Basis | 1.46 | lb/yd² | 0.785 | lb/yd² | 2.65 | lb/yd2 | 1.832 | lb/yd² | 0.91 | lb/yd² | 0.87 | lb/yd² |
| Weight | 792 | g/m² | 427 | g/m² | 1438 | g/m2 | 995 | g/m² | 494 | g/m² | 472 | g/m² |
| Dielectric | 5.9 | kV | 3.4 | kV | 6.5 | kV | 3.2 | kV | | | | |
| Breakdown Voltage | | | | | | | | | | | | |
| Thermal | 0.11 | W/m-K | 0.11 | W/m-K | 0.17 | W/m-K | 0.18 | W/m-K | 0.098 | W/mK | 0.10 | W/mK |
| Conductivity | | | | | | | | | | | | |
| Gurley Stiffness | 41 | g | | | 79 | g | 14 | g | | | | |
| Density | 0.78 | g/cm³ | 0.82 | g/cm³ | 0.99 | g/cm3 | 1.04 | g/cm³ | 0.99 | g/cm³ | 0.89 | g/cm³ |

| | | | | | | | | |
|---|---|---|---|---|---|---|---|---|
| Tensile | 59 | lb/in | 43 | lb/in | 406 | lb/in | 324 | Lb/in |
| Strength | 104 | N/cm | 75 | N/cm | 711 | N/cm | 567 | N/cm |

| | | | | | | |
|---|---|---|---|---|---|---|
| Elongation to | 0.61% | 0.54% | 2.4% | 3.6% | | |
| Break, MD | | | | | | |
| Flexibility | n/a | Pass | n/a | Pass | | |
| UL-94 | V-0, 5 VA | V-0, 5 VA | V-0, 5 VA | V-0, 5 VA | | |
| Flammability | | | | | | |
| Torch | Pass | Pass | Pass | Pass | Fail - small | Fail - small |
| Flame | | | | | holes < 0.1 | holes < 0.1 |
| Test | | | | | inch at 5 | inch at 2 |
| | | | | | minutes | minutes |
| Sandblast | Fail, holes | Fail, holes | Pass | Pass | | |
| Test | | | (no holes) | (no holes) | | |

TABLE 4
Comparison of Properties for Conventional Flame Resistant Materials

| | Comparative | | Comparative | | Comparative | | Comparative | | Comparative | |
|---|---|---|---|---|---|---|---|---|---|---|
| | Sample 6 | | Sample 7 | | Sample 8 | | Sample 9 | | Sample 10 | |
| Thickness* | 125 | Mil | 17 | Mil | 10.2 | Mil | 30.4 | Mil | 9 | Mil |
| | 3.17 | mm | 0.43 | mm | 0.26 | mm | 0.77 | mm | 0.23 | mm |
| Basis | 0.063 | lb/yd² | | | 1.01 | lb/yd² | 1.56 | lb/yd² | 0.37 | lb/yd² |
| Weight* | 34 | g/m² | | | 547 | g/m² | 847 | g/m² | 201 | g/m² |

| | | | | | |
|---|---|---|---|---|---|
| UL-94 | | V-0 | V-0 | V-0 | V-0, 5 VA |
| Flammability | | | | | |
| Torch | 0.75 inch hole | Fail - 2 inch | Fail - blistered, | Fail - blistered, | Fail - cracks |
| Flame | formed in 1 | hole formed | warped, and | warped, and | formed from |
| Test | second | within 1 | fractured into 2 | then irregular 1 | twisting in 18 |
| | | second | pieces in 3 | inch hole in 16 | seconds, 0.25 |
| | | | seconds | seconds | inch hole at 33 |
| | | | | | seconds |

*values taken from product data sheet

Various modifications of the exemplary electrical insulating materials described herein including equivalent processes, as well as numerous structures to which the present invention may be applicable will be readily apparent to those of skill in the art to which the present invention is directed upon review of the present specification.

1. A flame resistant electrical insulating material comprising:
glass fibers;
a particulate filler mixture, wherein the particulate filler mixture comprises glass bubbles and kaolin clay; and
an inorganic binder,
wherein the insulating material has a UL-94 flammability rating of V-0, 5VA.

2. The insulating material of claim 1, comprising from about 3 wt. % to 25 wt. % glass fibers based on the composition of the insulating material.

3. The insulating material of claim 2, wherein glass fibers comprise glass staple fibers and micro glass fibers.

4. The insulating material of claim 3, wherein a ratio of glass staple fibers to micro glass fibers is 5:1 to 1:3.

5. (canceled)

6. The insulating material of claim 1, wherein the insulating material comprises between about 55 wt. % to 80 wt. % of kaolin clay and from about 5 wt. % to 15 wt. % glass bubbles based on the composition of the insulating material.

7. The insulating material of claim 1, wherein the insulating material comprises 3 wt. % to 25 wt. % glass fibers, 20 wt. % to 80 wt. % of kaolin clay, 5 wt. % to 15 wt. % glass bubbles, and 5 wt. % to 20 wt. % inorganic binder.

8. A flame resistant electrical insulating material comprising:
glass fibers;
a particulate filler mixture, wherein the particulate filler mixture comprises glass bubbles, mica and kaolin clay; and
an inorganic binder,
wherein the insulating material has a UL-94 flammability rating of V-0, 5VA.

9. The insulating material of claim 8, wherein the insulating material comprises 20 wt. % to 45 wt. % of kaolin clay, 25 wt. % to 45 wt. % mica and 5 wt. % to 15 wt. % glass bubbles based on the composition of the insulating material.

10. The insulating material of claim 1, wherein the inorganic binder comprises at least one of sodium silicate and potassium silicate.

11. The insulating material of claim 1, wherein the insulating material is not punctured after direct exposure to a 2054° C. (3730° F.) flame for at least 10 minutes.

12. The insulating material of claim 1, wherein the insulating material is a flexible material that can be wrapped around a 3-inch mandrel without cracking or damaging said material.

13. The insulating material of claim 1, wherein the insulating material has a thermal conductivity of less than 0.15 W/m-K.

14. The insulating material of claim 1, wherein the insulating material has a density of 1.0 g/cm³ or lower.

15. The insulating material of claim 1, wherein the insulating material further comprises an inorganic fabric layer disposed on one side thereof.

16. (canceled)

17. A protective device, comprising:
a flame resistant electrical insulating material comprising:
glass fibers;
a particulate filler mixture, wherein the particulate filler mixture comprises glass bubbles and kaolin clay; and
an inorganic binder, wherein the flame resistant electrical insulating material has a UL-94 flammability rating of V-0, 5VA;
wherein the flame resistant electrical insulating material is incorporated as part of a lithium ion battery cell, module or pack.

18. (canceled)

19. The insulating material of claim 8, wherein the inorganic binder comprises at least one of sodium silicate and potassium silicate.

20. The insulating material of claim 8, wherein the insulating material is not punctured after direct exposure to a 2054° C. (3730° F.) flame for at least 10 minutes.

21. The insulating material of claim 8, wherein the insulating material is a flexible material that can be wrapped around a 3-inch mandrel without cracking or damaging said material.

22. The insulating material of claim 8, wherein the insulating material has a thermal conductivity of less than 0.15 W/m-K.

23. The insulating material of claim 8, wherein the insulating material further comprises an inorganic fabric layer disposed on one side thereof.
